(19) United States
(12) Patent Application Publication
(10) Pub. No.: US 2007/0285012 A1
(43) Pub. Date: Dec. 13, 2007

(54) Plasma display apparatus

(76) Inventor: Jong Woon Bae, Gumi-si (KR)

Correspondence Address: KED & ASSOCIATES, LLP, P.O. Box 221200, Chantilly, VA, 20153-1200, US

(21) Appl. No.: 11/594,335

(22) Filed: Nov. 8, 2006

(30) Foreign Application Priority Data
Jun. 9, 2006 (KR) 10-2006-0052130

(51) Int. Cl. H01J 17/49

(52) U.S. Cl. 313/582

(57) ABSTRACT

The present invention relates to a plasma display apparatus. The plasma display apparatus includes an upper substrate, first and second electrodes formed on the upper substrate, a lower substrate disposed opposite to the upper substrate, a third electrode formed on the lower substrate, and a barrier rib formed on the lower substrate, for partitioning a discharge cell. At least one of the first and second electrodes is formed of one layer. The barrier rib is formed using a photosensitive material. The photosensitive material includes an inorganic component containing glass particle, and an organic component containing a photosensitive compound. In accordance with the plasma display apparatus of the present invention, since transparent electrodes made of ITO are removed, the manufacturing cost of a plasma display panel can be saved. Furthermore, the protruding electrodes are projected from the scan electrode or the sustain electrode line to the center of the discharge cell or in an opposite direction to that of the center of the discharge cell. It is therefore possible to lower a firing voltage and can increase discharge diffusion efficiency within a discharge cell.

This application claims the benefit of Korean Patent Application No. 10-2006-0052130 filed on Jun. 9, 2006, and Korean Patent Application No. 10-2006-0048820 filed on May 30, 2006, which are hereby incorporated by reference for all purposes as if fully set forth herein.

### BACKGROUND OF THE INVENTION

1. Field of the Invention

The present invention relates, in general, to a plasma display apparatus and, more particularly, to a panel included in a plasma display apparatus.

2. Background of the Related Art

In a plasma display panel, a barrier rib formed between an upper substrate and a lower substrate forms one unit cell. Each cell is filled with an inert gas containing a primary discharge gas, such as neon (Ne), helium (He) or a mixed gas of Ne+He, and a small amount of xenon (Xe). If the inert gas is discharged with a high frequency voltage, it generates vacuum ultraviolet rays. The vacuum ultraviolet rays excite phosphor formed between the barrier ribs, so that an image is implemented. The plasma display panel can be made thin and light, and has thus been in the spotlight as the next-generation display devices.

FIG. 1 is a perspective view showing the construction of a general plasma display panel. As shown in FIG. 1, the plasma display panel includes an upper panel 100 and a lower panel 110, which are parallel to each other with a predetermined distance therebetween.

In the upper panel 100, a plurality of sustain electrode pairs in which a scan electrode 102 and a sustain electrode 103 are formed in pairs is arranged on an upper substrate 101 serving as a display surface on which an image is displayed. In the lower panel 110, a plurality of address electrodes 113 crossing the plurality of sustain electrode pairs are arranged on a lower substrate 111 serving as a rear surface.

The upper panel 100 includes the pair of the scan electrode 102 and the sustain electrode 103. The scan electrode 102 includes a transparent electrode 102a formed of transparent ITO (Indium Tin Oxide) and a bus electrode 102b, and the sustain electrode 103 includes a transparent electrode 103a formed of transparent ITO and a bus electrode 103b. The scan electrode 102 and the sustain electrode 103 are covered with an upper dielectric layer 104 and a protection layer 105 is formed on the upper dielectric layer 104.

The lower panel 110 includes barrier ribs 112 for partitioning discharge cells. A plurality of address electrodes 113 are also disposed parallel to the barrier rib 112. On the address electrodes 113 are coated R (Red), G (Green), and B (Blue) phosphors 114. A lower dielectric layer 115 is formed between the address electrodes 113 and the phosphors 114.

Meanwhile, the transparent electrodes 102a and 103a constituting the scan electrode 102 and the sustain electrode 103, respectively, of the conventional plasma display panel, is formed using expensive ITO. Therefore, the transparent electrodes 102a and 103a cause to increase the manufacturing cost of the plasma display panel. To solve the problems, recently, the primary object in view is to manufacture a plasma display panel that can secure a visibility characteristic sufficient for a user to view an image and a driving characteristic while saving the manufacturing cost.

### SUMMARY OF THE INVENTION

Accordingly, the present invention has been made in view of the above problems occurring in the prior art, and it is an object of the present invention to provide a plasma display apparatus, in which it can save the manufacturing cost of a panel included in the plasma display apparatus by removing transparent electrodes made of ITO.

To achieve the above object, a plasma display apparatus according to an embodiment of the present invention includes an upper substrate, first and second electrodes formed on the upper substrate, a lower substrate disposed opposite to the upper substrate, a third electrode formed on the lower substrate, and a barrier rib formed on the lower substrate, for partitioning a discharge cell. At least one of the first and second electrodes is formed of one layer. The barrier rib is formed using a photosensitive material. The photosensitive material includes an inorganic component containing glass particle, and an organic component containing a photosensitive compound.

Preferably, at least one of the first and second electrodes includes a line unit formed in a direction to cross the third electrode, and a projection unit projected from the line unit.

The inorganic component preferably contains the glass particle of 60 weight % or more. It is preferred that a difference between an average refractive index of the inorganic component and an average refractive index of the organic component be 0.2 or less. It is also preferred that an average refractive index of the inorganic component be set in a range of 1.5 to 1.65.

It is preferred that a top width of the barrier rib be set in a range of 30 to 50 μm, a bottom width of the barrier ribs be set in a range of 60 to 80 μm, and a height of the barrier rib be set in a range of 100 to 140 μm.

It is preferred that the barrier rib have a dielectric constant of 6 to 10, and a dielectric layer having a thickness of 30 to 40 μm be formed on at least one of the upper substrate and the lower substrate.

It is preferred that a top width of the barrier rib and a thickness of the dielectric layer have a ratio of 5:3 to 3:4 and a bottom width of the barrier rib and a thickness of the dielectric layer have a ratio of 8:3 to 3:2. Preferably, a plasma display panel in which the upper substrate and the lower substrate are formed includes lead (Pb) of 0.1 weight % or 1000 PPM or less.

It is preferred that the photosensitive material include 50 to 96 weight % of the inorganic component and 5 to 50 weight % of the organic component. The inorganic component preferably includes titanium oxide (TiO₂). It is also preferred that the glass particle include at least one of lithium oxide, natrium oxide, and potassium oxide, which has 3 to 20 weight %, or at least one of bismuth oxide and lead oxide, which has 5 to 50 weight %.

It is preferred that the glass particle include at least one of bismuth oxide and lead oxide, which is 5 to 30 weight %, and at least one of lithium oxide, natrium oxide, and potassium oxide, which has 3 to 15 weight %. It is preferred that a dielectric layer be formed on the upper substrate, and at least one of the first and second electrodes have a color darker than that of the dielectric layer.

A plasma display apparatus according to another embodiment of the present invention includes an upper substrate, first and second electrodes formed on the upper substrate, a lower substrate disposed opposite to the upper substrate, a third electrode formed on the lower substrate, and a barrier rib formed on the lower substrate, for partitioning a discharge cell. At least one of the first and second electrodes is formed of one layer. The barrier rib is formed using a photosensitive material. The photosensitive material includes an inorganic component containing glass particle, and an organic component containing a photosensitive compound. A difference between an average refractive index of the inorganic component and an average refractive index of the organic component is set in a range of −0.1 to 0.2.

A plasma display apparatus according to still another embodiment of the present invention includes an upper substrate, first and second electrodes formed on the upper substrate, a lower substrate disposed opposite to the upper substrate, a third electrode formed on the lower substrate, and a barrier rib formed on the lower substrate, for partitioning a discharge cell. At least one of the first and second electrodes is formed of one layer and includes a line unit formed in a direction to cross the third electrode and a projection unit projected from the line unit. The barrier rib is formed using a photosensitive material. The photosensitive material includes an inorganic component having an average refractive index of 1.5 to 1.65.

### BRIEF DESCRIPTION OF THE DRAWINGS

Further objects and advantages of the invention can be more fully understood from the following detailed description taken in conjunction with the accompanying drawings in which:

FIG. 1 is a perspective view showing the construction of a general panel included in a plasma display apparatus;

FIG. 2 is a perspective view showing the construction of a plasma display panel according to an embodiment of the present invention;

FIG. 3 is a schematic cross-sectional view showing the structure of a lower panel in which a barrier rib is formed according to an embodiment of the present invention;

FIG. 4 is a cross-sectional view showing the arrangement of electrodes of the plasma display panel;

FIG. 5 is a cross-sectional view showing a first embodiment of the sustain electrode structure of the plasma display panel according to the present invention;

FIG. 6 is a cross-sectional view showing a second embodiment of the sustain electrode structure of the plasma display panel according to the present invention;

FIG. 7 is a cross-sectional view showing a third embodiment of the sustain electrode structure of the plasma display panel according to the present invention;

FIG. 8 is a cross-sectional view showing a fourth embodiment of the sustain electrode structure of the plasma display panel according to the present invention;

FIG. 9 is a cross-sectional view showing a fifth embodiment of the sustain electrode structure of the plasma display panel according to the present invention;

FIG. 10 is a cross-sectional view showing a sixth embodiment of the sustain electrode structure of the plasma display panel according to the present invention;

FIG. 11 is a cross-sectional view showing a seventh embodiment of the sustain electrode structure of the plasma display panel according to the present invention;

FIG. 12 is a cross-sectional view showing an eighth embodiment of the sustain electrode structure of the plasma display panel according to the present invention;

FIG. 13 is a cross-sectional view showing a ninth embodiment of the sustain electrode structure of the plasma display panel according to the present invention;

FIG. 14 is a cross-sectional view showing a tenth embodiment of the sustain electrode structure of the plasma display panel according to the present invention;

FIGS. 15A and 15B cross-sectional view showing an eleventh embodiment of the sustain electrode structure of the plasma display panel according to the present invention;

FIG. 16 is a timing diagram illustrating an embodiment of a method of driving the plasma display panel with one frame being time-divided into a plurality of subfields; and

FIG. 17 is a timing diagram illustrating an embodiment of driving signals for driving the plasma display panel.

### DETAILED DESCRIPTION OF THE PREFERRED EMBODIMENT

A plasma display apparatus according to the present invention will now be described in detail in connection with specific embodiments with reference to the accompanying drawings.

It is however to be noted that the plasma display apparatus according to the present invention is not limited to the following embodiments, but may include other embodiments.

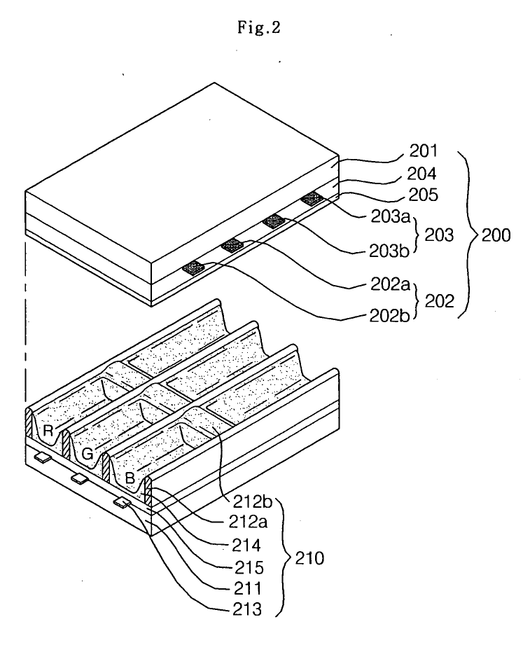

The plasma display apparatus according to an embodiment of the present invention will be described in detail with reference to FIGS. 2 to 17. FIG. 2 is a perspective view showing the construction of a plasma display panel according to an embodiment of the present invention.

Referring to FIG. 2, the plasma display panel includes an upper panel 200 and a lower panel 210 which are coalesced with a predetermined distance therebetween. The plasma display panel includes address electrodes 213 formed on a lower substrate 211 in a direction crossing sustain electrode pairs 202 and 203, and barrier ribs 212 formed over the lower substrate 211, for partitioning a plurality of discharge cells.

The upper panel 200 includes the sustain electrode pairs 202 and 203 formed in pairs on an upper substrate 201. The sustain electrode pairs 202 and 203 are divided into the scan electrode 202 and the sustain electrode 203 depending on its function. The sustain electrode pairs 202 and 203 are covered with an upper dielectric layer 204 that limits the discharge current and insulates between the electrode pairs. A protection layer 205 is formed on a top surface of the upper dielectric layer 204. The protection layer 205 serves to protect the upper dielectric layer 204 from sputtering of charged particles generated at the time of gas discharge and increase emission efficiency of secondary electrons.

Discharge spaces provided between the upper substrate 201, the lower substrate 211, and the barrier rib 212 are injected with a discharge gas. It is preferred that the discharge gas contain xenon (Xe) of 10% or more. If xenon (Xe) is contained in the discharge gas with the above mixed ratio, discharge/emission efficiency and luminance of the plasma display panel can be improved.

The lower panel 210 includes the barrier ribs 212 that partition a plurality of discharge spaces (i.e., the discharge cells) on the lower substrate 211. Furthermore, the address electrodes 213 are disposed to cross the sustain electrode pairs 202 and 203. A phosphor 214, which is emitted by ultraviolet rays generated during the discharge of gas to generate a visible ray, is coated on surfaces of a lower dielectric layer 215 and the barrier ribs 212.

The barrier ribs 212 include longitudinal barrier ribs 212a formed parallel to the address electrodes 213, and traverse barrier ribs 212b formed to cross the address electrodes 213. The barrier ribs 212 partition the discharge cells physically and serve to prevent ultraviolet rays and a visible ray generated by a discharge from leaking to neighboring discharge cells.

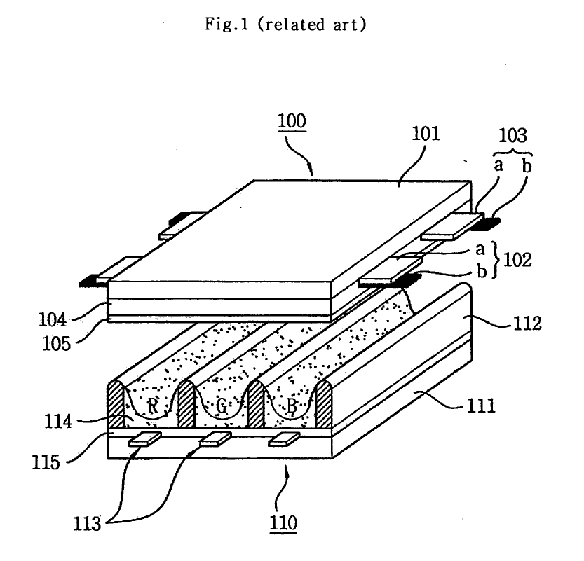

Furthermore, in the plasma display panel according to the present invention, the sustain electrode pairs 202 and 203 include only opaque metal electrodes unlike the conventional sustain electrode pairs 102 and 103 shown in FIG. 1. In other words, the sustain electrode pairs 202 and 203 of the present invention are formed using silver (Ag), copper (Cu), chrome (Cr) or the like, which are the materials of the conventional bus electrode, not ITO that is the material of the conventional transparent electrode. That is, each of the sustain electrode pairs 202 and 203 of the plasma display panel according to the present invention does not include the conventional ITO electrode, but includes only one layer of the bus electrode.

For example, each of the sustain electrode pairs 202 and 203 according to the present invention may be formed using silver (Ag). It is preferred that the silver (Ag) have a photosensitive property. It is also preferred that each of the sustain electrode pairs 202 and 203 according to the present invention have a color darker than that of the upper dielectric layer 204 or the lower dielectric layer 214 and has a light transmittance, which is lower than that of the upper dielectric layer 204 or the lower dielectric layer 214.

In the discharge cell, the R, G, and B phosphor layers 214 may have a symmetrical structure having the same pitch or an asymmetrical structure having a different pitch. In the case where the discharge cell has the asymmetrical structure, it is preferred that the order be “the pitch of the R cell<the pitch of the G cell<the pitch of the B cell”.

It is preferred that each of the sustain electrodes 202 and 203 includes a plurality of electrode lines within one discharge cell, as shown in FIG. 2. That is, it is preferred that the sustain electrode 202 include two electrode lines 202a and 202b, and the second sustain electrode 203 include two electrode lines 203a and 203b disposed symmetrical to the sustain electrode 202 with the discharge cell intervened therebetween.

It is also preferred that the first and second sustain electrodes 202 and 203 be the scan electrode and the sustain electrode, respectively. This is because the aperture ratio and discharge diffusion efficiency depending on the opaque sustain electrode pairs 202 and 203 are taken into consideration. In other words, an electrode line having a narrow pitch is used in consideration of the aperture ratio, whereas a plurality of electrode lines are used in consideration of the discharge diffusion efficiency. The number of the electrode lines may be decided taking both the aperture ratio and the discharge diffusion efficiency into consideration.

The construction shown in FIG. 2 is only an embodiment of the construction of the plasma display panel according to the present invention and the present invention is not limited to the construction of the plasma display panel as shown in FIG. 2. For example, a black matrix (BM) having a light-shielding function of reducing the reflection of external light by absorbing the light and a function of improving the purity and contrast of the upper substrate 201 may be formed on the upper substrate 201.

The black matrix may have a separation type BM structure or an integration type BM structure. In the separation type BM, a layer (a black layer) formed between the sustain electrodes 202 and 203 and the upper substrate 201 is not connected to the black matrix. In the integration type BM, the black layer is connected to the black matrix to form the integration type. Furthermore, when the black matrix has the separation type BM, the black matrix and the black layer may be formed using different materials. When the black matrix has the integration type BM, the black matrix and the black layer may be formed using the same material.

Furthermore, the barrier rib structure of the panel shown in FIG. 2 has a close type in which the discharge cell is closed by the longitudinal barrier rib 212a and the traverse barrier rib 212b, but may have a stripe type including only the longitudinal barrier ribs, a fish bone type in which projection units are formed at predetermined intervals on the longitudinal barrier ribs, or the like.

An embodiment of the present invention may be applied to not only the barrier rib structure shown in FIG. 2, but also barrier rib structures having a variety of shapes. For example, the barrier rib structures may include a differential type barrier rib structure in which the longitudinal barrier rib 212a and the traverse barrier rib 212b have different heights, a channel type barrier rib structure in which a channel, which can be used as an exhaust passage, is formed in one or more of the longitudinal barrier rib 212a and the traverse barrier rib 212b, a hollow type barrier rib structure in which a hollow is formed in one or more of the longitudinal barrier rib 212a and the traverse barrier rib 212b, and so on.

In the differential type barrier rib structure, it is preferred that the height of the traverse barrier rib 212b be high. In the channel type barrier rib structure or the hollow type barrier rib structure, it is preferred that a channel or a hollow be formed in the traverse barrier rib 212b.

Meanwhile, in the present embodiment, it has been shown and described that the R, G, and B discharge cells are arranged on the same line. However, the R, G, and B discharge cells may be arranged in different forms. For example, the R, G, and B discharge cells may have a delta type arrangement in which they are arranged in a triangle. Furthermore, the discharge cells may be arranged in a variety of forms, such as square, pentagon and hexagon.

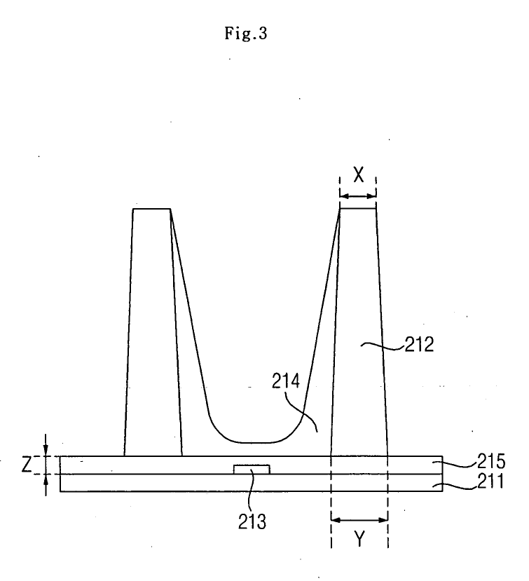

FIG. 3 is a schematic cross-sectional view showing the structure of the lower panel in which the barrier ribs are formed according to the present invention. As described above with reference to FIG. 2, the address electrode 213, the lower dielectric layer 215, the barrier ribs 212, and the phosphor layer 214 are formed on the lower substrate 211.

If the distance between the two sustain electrodes 202 and 203 are increased so as to secure the aperture ratio of the plasma display panel as described above, the pitch of the discharge cell is increased. Therefore, in order to secure the number of pixels required per panel, it is preferred that a top width X of the barrier rib 212 be set to 30 to 50 μm, a bottom width Y of the barrier rib 212 be set to 60 to 80 μm, and the dielectric constant of the barrier rib 212 be set to 6 to 10, and the height of the barrier rib 212 be set to 100 to 140 μm.

As the pitch of the barrier rib 212 is reduced as described above, it is preferred that a thickness Z of the lower dielectric layer 215 and a thickness of the upper dielectric layer 214 be set in a range of 30 to 40 μm so as to insulate between the sustain electrodes 202 and 203 efficiently. Furthermore, in order to efficiently insulate between the two sustain electrodes 202 and 203 while securing the pixel number required in the plasma display panel according to the present invention, it is preferred that the ratio between the top width X of the barrier rib 212 and the thickness of the dielectric layers 214 and 215 is set in a range of 5:3 to 3:4, and the ratio between the bottom width Y of the barrier rib 212 and the thickness of the dielectric layers 214 and 215 is set in a range of 8:3 to 3:2.

It is preferred that the barrier rib 212 of the plasma display panel according to the present invention be formed using a photosensitive material comprising an inorganic component and an organic component containing a photosensitive compound. The barrier rib 212 may be formed by a process of forming a pattern using a photolithography process and then performing sintering to form an inorganic pattern. The photolithography process includes forming a pattern through a photochemical reaction by exposing a photosensitive material to light having a specific wavelength through a mask in which a pattern is formed.

The photosensitive material for forming the barrier rib 212 may include an inorganic component containing glass particles of 60 weight % or more and an organic component containing a photosensitive compound. It is preferred that the difference between an average refractive index N1 of the inorganic component and an average refractive index N2 of the organic component be set in a range of −0.1 to 0.2. It is also preferred that the average refractive index N1 of the inorganic component range from 1.5 to 1.65.

If the photosensitive material is formed of the inorganic component and the photosensitive organic component having the above-mentioned ratio and average refractive index, barrier ribs having a high-accuracy pattern and a small pitch can be formed.

It is also preferred that the photosensitive material include 50 to 96 weight % of the inorganic component and 5 to 50 weight % of the organic component. If the photosensitive material includes the inorganic component and the photosensitive organic component having the above-mentioned ratio, a reduction ratio and variation in the shape when sintering the barrier rib 212 can be reduced and barrier ribs having a small pitch can be formed conveniently.

The inorganic component included in the photosensitive material may include glass, alumina, cordierite, gold, platinum, silver, copper, nickel, palladium, tungsten, RuO₂ and the like, and more preferably glass or ceramics including insulators, such as silicon oxide, boron oxide or aluminum oxide, as a major component.

The inorganic component may preferably include a photocatalyst, such as titanium oxide (TiO₂), in order to accelerate the photochemical reaction of the photosensitive organic compound.

It is preferred that at least one of lithium oxide, natrium oxide, and potassium oxide be included in the glass particle included in the inorganic component in an amount of 3 to 20 weight % based on the total weight of the glass particle.

If the above-mentioned glass particle is used, a thermal softening temperature and the coefficient of thermal expansion of the inorganic component can be controlled easily and the average refractive index between the inorganic component and the organic component can be set to 0.1 or less conveniently. It is further preferred that the glass particle include lithium oxide or potassium oxide so as to increase the stability of the photosensitive material and reduce the refractive index of the inorganic component.

It is preferred that at least one of lithium oxide and lead oxide be included in the glass particle in an amount of 5 to 50 weight % based on the total weight of the glass particle. It is therefore possible to obtain a photosensitive barrier rib material having a temperature characteristic in which it can be patterned on the lower substrate 211, i.e., a glass substrate and also to increase the port lifespan of the photosensitive material.

In addition, it is preferred that at least one of lithium oxide and lead oxide be included in the glass particle in an amount of 5 to 30 weight % based on the total weight of the glass particle, and it is more preferred that at least one of lithium oxide, natrium oxide, and potassium oxide be included in the glass particle in an amount of 3 to 15 weight % based on the total weight of the glass particle.

If the glass particle as described above is used, it is possible to prevent a mismatch between the photosensitive material and the glass substrate, which is incurred since the coefficient of thermal expansion of the photosensitive material is deviated from a target value, and also to reduce a thermal softening point.

It is preferred that the photosensitive barrier rib material may not include lead (Pb), or lead (Pb) may be included in the photosensitive barrier rib material in an amount of 0.1 weight % or 1000 PPM (Parts Per Million) or less based on the total weight of the plasma display panel.

When a total content of the Pb component is 1000 PPM or less, the content of Pb against the weight of the plasma display panel may be set to 1000 PPM or less.

Alternatively, the content of the Pb component included in a specific constituent element of the plasma display pane may be set to 1000 PPM or less. For example, the content of the Pb component of the barrier rib, the Pb component of the dielectric layer or the Pb component in the electrode may be set to 1000 PPM or less in an amount of each of the constituent elements (the barrier rib, the dielectric layer, and the electrode).

Furthermore, the content of the Pb component of the entire constituent elements, such as the barrier rib, the dielectric layer, the electrode, and the phosphor layer of the plasma display panel, may be set to 1000 PPM or less in a total weight of the plasma display panel. The reason why a total content of the Pb component is set to 1000 PPM or less as described above is that the Pb component may have a bad influence on the human body.

The organic component includes a photosensitive component containing photosensitive monomer, photosensitive oligomer or photosensitive polymer, and preferably further includes an additive component, such as a binder, a photopolymerization initiator, an ultraviolet absorbent, a sensitizer, an increment and decrement agent, a polymerization preventer, a plasticizer, a thickener, an organic solvent, an antioxidant, a dispersant, an organic or inorganic anti-setting agent or a leveling agent.

The photosensitive component may include both a non-photosoluble type and a photosoluble type. The non-photosoluble type may include a functional monomer, oligomer or polymer having one or more unsaturated groups, etc. within a molecule. The non-photosoluble type may also include photosensitive compounds, such as aromatic diazo compounds, aromatic azide compounds, and organic halogen compounds, diazo resin (i.e., a condensate of diazo-based amine and formaldehyde), and the like.

Furthermore, the photosoluble type may include a complex of inorganic salts of diazo compounds and organic acids, quinone diazo, phenol in which quinone diazo kinds are condensated by a proper polymer binder, naphthoquinone-1,2-diazid-5-sulfonate Esters of novolak resin, and the like.

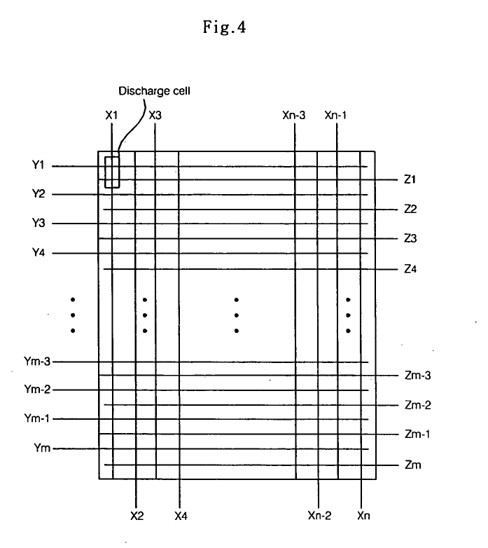

FIG. 4 is a cross-sectional view showing the arrangement of the electrodes of the plasma display panel. The plurality of discharge cells constituting the plasma display panel may be arranged in matrix form as shown in FIG. 4.

The plurality of discharge cells are respectively disposed at the intersections of scan electrode lines Y1 to Ym, sustain electrodes line Z1 to Zm, and address electrodes lines X1 to Xn. The scan electrode lines Y1 to Ym are sequentially driven and the sustain electrode lines Z1 to Zm are commonly driven. The address electrode lines X1 to Xn are driven with them being divided into even-numbered lines and odd-numbered lines.

The electrode arrangement shown in FIG. 4 is only an embodiment of the electrode arrangement of the plasma display panel according to the present invention. It is to be understood that the present invention is not limited to the electrode arrangement and driving method of the plasma display panel shown in FIG. 4. For example, the present invention may be applied to a dual scan method in which two of the scan electrode lines Y1 to Ym are driven at the same time.

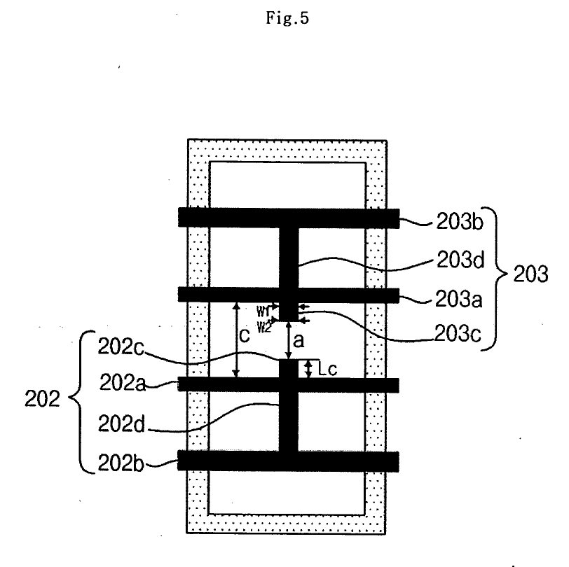

FIG. 5 is a cross-sectional view showing a first embodiment of the sustain electrode structure of the plasma display panel according to the present invention. Only the arrangement structure of the sustain electrode pairs 202 and 203 formed within one discharge cell of the plasma display panel shown in FIG. 2 are simply shown in FIG. 5.

As shown in FIG. 5, the sustain electrodes 202 and 203 according to a first embodiment of the present invention are formed in pairs symmetrically on the substrate around the center of the discharge cell. Each of the sustain electrodes includes a line unit including two or more electrode lines 202a and 202b, or 203a and 203b crossing the discharge cell, and a projection unit including one or more protruding electrodes 202c and 203c that are connected to the electrode lines 202a and 203a, respectively, which are the closest to the center of the discharge cell, and are projected toward the center of the discharge cell within the discharge cell. Furthermore, it is preferred that each of the sustain electrodes 202 and 203 further include one bridge electrode 202d or 203d that connects the two electrode lines 202a and 202b or 203a and 203b, as shown in FIG. 3.

The electrode lines 202a, 202b, 203a, and 203b cross the discharge cell and extend in one direction of the plasma display panel. The electrode line according to a first embodiment of the present invention has a narrow pitch so as to improve the aperture ratio. Furthermore, in order to improve the discharge diffusion efficiency, the plurality of electrode lines 202a, 202b, 203a, and 203b are used. It is, however, preferred that the number of the electrode lines is decide in consideration of the aperture ratio.

The protruding electrodes 202c and 203c are connected to the electrode lines 202a and 203a, respectively, which are the closest to the center of the discharge cell within one discharge cell and are preferably projected toward the center of the discharge cell. The protruding electrodes 202c and 203c serve to lower a firing voltage when the plasma display panel is driven. Since the firing voltage is increased due to a distance C between the electrode lines 202a and 203a, the protruding electrodes 202c and 203c are provided in the electrode lines 202a and 203a, respectively, in the first embodiment of the present invention. A discharge can begin even at a low firing voltage between the protruding electrodes 202c and 203c that are formed closely. It is therefore possible to lower the firing voltage of the plasma display panel. The firing voltage refers to a voltage level at which a discharge begins when a pulse is supplied to at least one of the sustain electrode pairs 202 and 203.

The protruding electrodes 202c and 203c have a very small size. Therefore, a width W1 of a portion at which the protruding electrode 202c or 203c is connected to the electrode line 202a or 203a of the protruding electrode 202c or 203c may be formed wider than a width W2 at the end of the protruding electrode due to the tolerance of the manufacturing process. The width W2 at the end of the protruding electrode may be formed wider than the width W1, if appropriate.

It is preferred that a distance between two neighboring electrode lines constituting each of the sustain electrode pairs 203 and 202 (i.e., a distance between the electrodes 203a and 203b or a distance between the electrodes 202a and 202b) be in a range of 80 to 120 μm. If a distance between the two neighboring electrode lines has the above-mentioned value, the aperture ratio of the plasma display panel can be secured sufficiently, the luminance of a display image can be improved, and the discharge diffusion efficiency within the discharge space can be increased.

It is preferred that the width W1 of the protruding electrode 202c or 203c is in a range of 35 to 45 μm. If the width of the protruding electrode 202c or 203c has the above-mentioned value, it is possible to prevent a reduction in the luminance of an image, which is incurred as light reflecting toward the front of a display device is precluded by the protruding electrodes 202c and 203c since the aperture ratio of the plasma display panel is low.

Furthermore, a distance “a” between the protruding electrodes 202c and 203c may preferably range from 15 to 165 μm. If the distance “a” between the protruding electrodes 202c and 203c has the above-mentioned value, the lifespan of the electrodes can be prevented from shortening because a discharge between the protruding electrodes 202c and 203c excessively occurs over a critical value. The protruding electrodes 202c and 203c can also have a firing voltage suitable for driving the plasma display panel.

The bridge electrodes 202d and 203d connect the two electrode lines 202a and 202b, and 203a and 203b, respectively, which constitute the sustain electrodes 202 and 203, respectively. The bridge electrodes 202d and 203d help a discharge, which is started through the protruding electrodes 202c and 203c, to easily diffuse into the electrode lines 202b and 203b that are far from the center of the discharge cell.

As described above, the electrode structure according to a first embodiment of the present invention can improve the aperture ratio by limiting the number of the electrode lines. Furthermore, a firing voltage can be lowered since the protruding electrodes 202c and 203c are formed. Furthermore, the discharge diffusion efficiency can be improved by the bridge electrodes 202d and 203d, and the electrode lines 202b and 203b that are far from the center of the discharge cell. This can improve the emission efficiency of the plasma display panel as a whole. That is, since the luminance of the plasma display panel can be at least the same as or higher than that of the conventional plasma display panel, the ITO transparent electrodes may not be used.

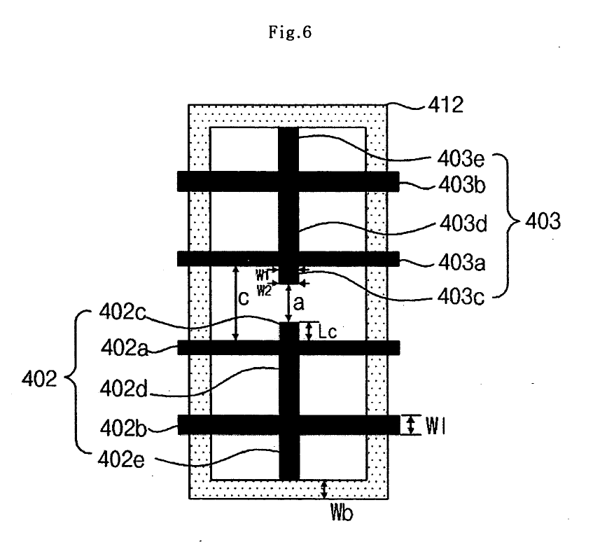

FIG. 6 is a cross-sectional view showing a second embodiment of the sustain electrode structure of the plasma display panel according to the present invention. Only the arrangement structure of sustain electrode pairs 402 and 403 formed within one discharge cell of the plasma display panel shown in FIG. 2 are shown in FIG. 6.

As shown in FIG. 6, the sustain electrode 402 includes two or more electrode lines 402a and 402b that cross the discharge cell, a first protruding electrode 402c that is connected to the electrode line 402a, which is the closest to the center of the discharge cell and is projected toward the center of the discharge cell within the discharge cell, a bridge electrode 402d that connects the two electrode lines 402a and 402b, and a second protruding electrode 402e that is connected to the electrode line 402b that is the furthest from the center of the discharge cell and is projected in an opposite direction to that of the center of the discharge cell within the discharge cell. Furthermore, the sustain electrode 403 includes two or more electrode lines 403a and 403b that cross the discharge cell, a first protruding electrode 403c that is connected to the electrode line 403a, which is the closest to the center of the discharge cell and is projected toward the center of the discharge cell within the discharge cell, a bridge electrode 403d that connects the two electrode lines 403a and 403b, and a second protruding electrode 403e that is connected to the electrode line 403b that is the furthest from the center of the discharge cell and is projected in an opposite direction to that of the center of the discharge cell within the discharge cell.

The electrode lines 402a, 402b, 403a, and 403b cross the discharge cell and extend in one direction of the plasma display panel. It is preferred that a sustain electrode line according to a second embodiment of the present invention has a narrow pitch in order to improve the aperture ratio. Preferably, a pitch W1 of the electrode line may be set within a range of 20 μm to 70 μm so that a discharge can be generated smoothly while improving the aperture ratio.

As shown in FIG. 6, the electrode lines 402a and 403a that are the closest to the center of the discharge cell are connected to the first protruding electrodes 402c and 403c, respectively. Furthermore, the electrode lines 402a and 403a that are the closest to the center of the discharge cell form a path along which a discharge begins diffusing simultaneously when the discharge begins.

The electrode lines 402b and 403b that are the furthest from the center of the discharge cell are connected to the second protruding electrodes 402e and 403e. Furthermore, the electrode lines 402b and 403b that are the furthest from the center of the discharge cell serve to diffuse a discharge up to near the discharge cell.

The first protruding electrodes 402c and 403c are connected to the electrode lines 402a and 403a, respectively, which are the closest to the center of the discharge cell within one discharge cell and are projected toward the center of the discharge cell. It is preferred that the first protruding electrodes 402c and 403c are formed at the centers of the electrode lines 402a and 403a, respectively. The first protruding electrodes 402c and 403c are formed at the centers of the electrode lines in a corresponding manner, so that a firing voltage of the plasma display panel can be further lowered effectively.

It is preferred that a width w1 of each of the protruding electrodes 402c and 403c is in a range of 35 to 45 μm and a distance a between the protruding electrodes 402c and 403c is in a range of 15 to 165 μm. The critical meaning of the highest limit value and the lowest limit value of the pitch and distance of the protruding electrodes 402c and 403c is the same as that descried with reference to FIG. 5 and will not be described.

The bridge electrodes 402d and 403d are connected to the two electrode lines 402a and 402b, and 403a and 403b, respectively, which form the sustain electrodes 402 and 403, respectively. The bridge electrode 402d helps a discharge, which begins through the protruding electrode 402d, to easily diffuse into the electrode line 402b that is the furthest from the center of the discharge cell. Furthermore, the bridge electrode 403d helps a discharge, which begins through the protruding electrode 403d, to easily diffuse into the electrode line 403b that is the furthest from the center of the discharge cell.

It is shown in FIG. 6 that the bridge electrodes 402d and 403d are located within the discharge cell. However, the bridge electrodes 402d and 403d may be formed on a barrier rib 412 partitioning the discharge cell, if needed. Accordingly, in a second embodiment of the sustain electrode structure of the plasma display panel according to the present invention, a discharge can be diffused even into the spaces between the electrode lines 402b and 403b and the barrier rib 412. Therefore, since discharge diffusion efficiency is improved, emission efficiency of the plasma display panel can be improved.

Furthermore, the second protruding electrodes 402e and 403e are connected to the electrode lines 402b and 403b, which are the furthest from the center of the discharge cell, and are projected in an opposite direction to that of the center of the discharge cell. A length of each of the second protruding electrodes 402e and 403e may preferably range from 50 to 100 μm. It helps a discharge to effectively diffuse into the discharge spaces that are the furthest from the center of the discharge cell.

As shown in FIG. 6, the second protruding electrodes 402e and 403e can be extended up to the barrier rib 412 partitioning the discharge cell. Furthermore, if the aperture ratio can be compensated for sufficiently in other portions, a portion of the second protruding electrodes 402e and 403e can be extended on the barrier rib 412 in order to further improve the discharge diffusion efficiency.

In the case where the second protruding electrodes 402e and 403e are not extended up to the barrier rib 412, however, it is preferred that a distance between the second protruding electrode 402e or 403e, and a neighboring barrier rib 412 is set in a range of 70 μm or less. When the distance between the second protruding electrode 402e or 403e, and the barrier rib 412 is 70 μm or less, a discharge can be diffused effectively into the discharge spaces that are the furthest from the center of the discharge cell.

In the second embodiment of the sustain electrode structure according to the present invention, the second protruding electrodes 402e and 403e are preferably formed at the centers of the electrode lines 402b and 403b, respectively, in order to uniformly diffuse a discharge into the periphery of the discharge cell.

Meanwhile, in the second embodiment of the present invention, it is preferred that a pitch Wb of a barrier rib located in a direction along which the second protruding electrode 402e or 403e extends, of barrier ribs partitioning the discharge cell, be set to 200 μm or less. It is also preferred that a black matrix (not shown) that secures bright contrast by absorbing external light and prevents radiated discharge light from diffusing into neighboring discharge cells and being displayed thereon be formed on the barrier rib 412.

If the pitch of the barrier rib 412 is set to 200 μm or less as described above, an area of the discharge cell can be increased. This can improve emission efficiency and can also compensate for a reduction in the aperture ratio, which is incurred by the second protruding electrode, etc. Preferably, the pitch Wb of the barrier rib located in a direction along which the second protruding electrode extends may be set in a range of 90 to 100 μm in order to obtain an optimal emission efficiency.

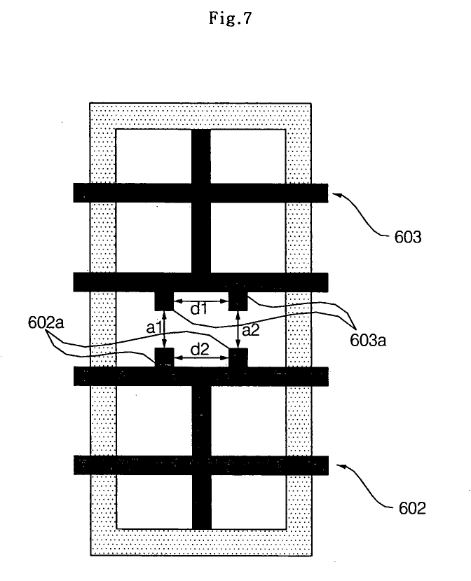

FIG. 7 is a cross-sectional view showing a third embodiment of the sustain electrode structure of the plasma display panel according to the present invention. The same portions as those described with reference to FIG. 6, of the sustain electrode structure shown in FIG. 7, will not be described in order to avoid redundancy.

In the third embodiment of the sustain electrode structure according to the present invention, two first protruding electrodes 602a and 603a are formed in sustain electrodes 602 and 603, respectively, as shown in FIG. 7. The first protruding electrodes 602a and 603a are connected to electrode lines, which are the closest to the center of a discharge cell, and are projected in a central direction of the discharge cell. It is preferred that the first protruding electrodes 602a and 603a are symmetrical to each other around the center of the electrode lines.

It is preferred that a pitch of each of the first protruding electrodes 602a and 603a be in a range of 35 to 45 μm. The critical meaning of the highest limit value and the lowest limit value of the pitch of the protruding electrodes is the same as that descried with reference to FIG. 5 and will not be described.

It is preferred that each of distances d1 and d2 between the two first protruding electrodes projected from one electrode line be 50 to 100 μm when a plasma display panel is a 42-inch size and VGA resolutions, 30 to 80 μm when a plasma display panel is a 42-inch size and XGA resolutions, and 40 to 90 μm when a plasma display panel is a 50-inch size and XGA resolutions.

If the distances d1 and d2 of the first protruding electrodes are set as described above, an aperture ratio capable of implementing the luminance of an image, which is required in a display device, can be secured. It is therefore possible to prevent power necessary for display from being consumed over a limit value, which is incurred as invalid power is increased because the first protruding electrodes are disposed too close to the barrier rib.

Since the two first protruding electrodes 602a and 603a are formed in the sustain electrodes 602 and 603, respectively, the area of the electrode at the center of the discharge cell can be widened. Accordingly, before a discharge begins, a firing voltage can be further lowered and a discharge speed can be increased because lots of spatial charges are formed within the discharge cell. Furthermore, after a discharge begins, luminance can be improved since an amount of wall charges is increased, and a discharge can be uniformly diffused over the whole discharge cell.

Furthermore, it is preferred that distances al and a2 between the first protruding electrodes 602a and 603a (i.e., the distances a1 and a2 between two protruding electrodes in a direction to cross electrode lines 602 and 603) be set in a range of 15 to 165 μm. The critical meaning of the highest limit value and the lowest limit value of the distances between the protruding electrode is the same as that descried with reference to FIG. 5 and will not be described.

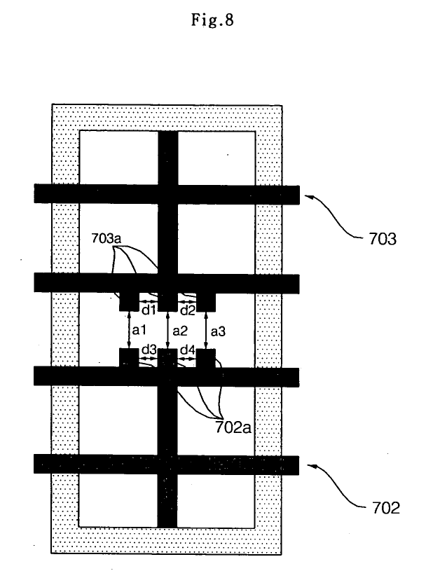

FIG. 8 is a cross-sectional view showing a fourth embodiment of the sustain electrode structure of the plasma display panel according to the present invention. The same portions as those described with reference to FIGS. 6 and 7, of the electrode structure shown in FIG. 8, will not be described in order to avoid redundancy.

In the fourth embodiment of the sustain electrode structure according to the present invention, sustain electrodes 702 and 703 include three first protruding electrodes 702a and 703a, respectively, as shown in FIG. 8.

The first protruding electrodes 702a or 703a are connected to one of electrode lines, which is close to the center of a discharge cell, and are projected toward the center of the discharge cell. It is preferred that one of the first protruding electrodes be formed at the center of the electrode lines and the remaining two first protruding electrodes be symmetrical to each other around the center of the electrode line.

The three first protruding electrodes 702a and 703a are formed in the sustain electrodes 702 and 703, respectively, as described above. Accordingly, a firing voltage can be further lowered and a discharge speed can become fast compared with the embodiments of FIGS. 6 and 7. Furthermore, luminance can be further improved after a discharge begins, and a discharge can be diffused over the whole discharge cell further uniformly.

By increasing the number of the first protruding electrodes as described above, the electrode area at the center of the discharge cell can be increased, a firing voltage can be lowered, and luminance can be improved. It is, however, to be noted that a strong discharge is generated at the center of the discharge cell and the brightest discharge light is radiated.

In other words, since light radiated from the center of the discharge cell is precluded as the number of the first protruding electrodes increases, radiated light is significantly reduced. Therefore, it is preferred that the structure of the sustain electrode be designed by selecting an optimal number taking both the firing voltage and luminance efficiency into consideration.

It is preferred that a pitch of each of the first protruding electrodes 702a and 703a be in a range of 35 to 45 μm and distances a1, a2, and a3 between the first protruding electrodes 702a and 703a be in a range of 15 to 165 μm. The critical meaning of the highest limit value and the lowest limit value of the pitch and distance of the first protruding electrodes 702a and 703a is the same as that descried with reference to FIG. 5 and will not be described.

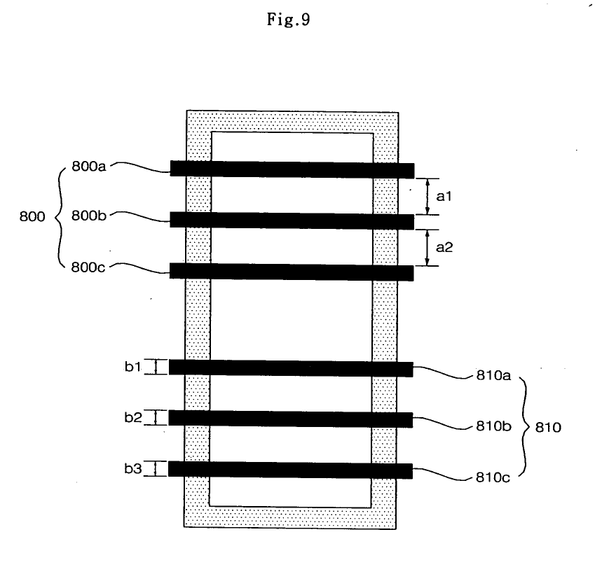

FIG. 9 is a cross-sectional view showing a fifth embodiment of the sustain electrode structure of the plasma display panel according to the present invention.

Referring to FIG. 9, sustain electrodes 800 and 810 include three electrode lines 800a, 800b, and 800c, and 810a, 810b, and 810c, respectively, which cross a discharge cell. The electrode lines cross the discharge cell and extend in one direction of the plasma display panel. The electrode lines have a narrow pitch, preferably a pitch ranging from 20 to 70 μm, in order to improve the aperture ratio and smoothly generate a discharge.

It is preferred that a thickness of the electrode lines 800a, 800b, 800c, 810a, 810b, and 810c of the sustain electrode pairs be in a range of 3 to 7 μm. Distances a1 and a2 between the three electrode lines constituting the sustain electrode 800 or 810 may be the same or different from each other. Furthermore, pitches b1, b2, and b3 of the electrode lines constituting the sustain electrode 800 or 810 may be the same or different from each other. The critical meaning of the highest limit value and the lowest limit value of the thickness of the electrode line is the same as that descried with reference to FIG. 2 and will not be described.

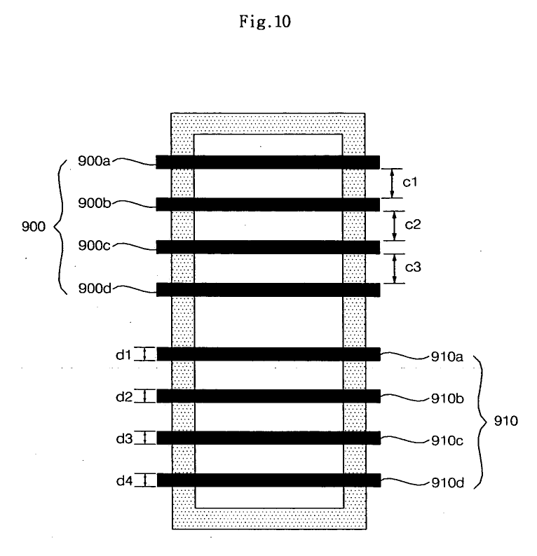

FIG. 10 is a cross-sectional view showing a sixth embodiment of the sustain electrode structure of the plasma display panel according to the present invention.

Referring to FIG. 10, sustain electrodes 900 and 910 includes four electrode lines 900a, 900b, 900c, and 900d, and 910a, 910b, 910c, and 910d, respectively, which cross a discharge cell. The electrode lines cross the discharge cell and extend in one direction of the plasma display panel. The electrode lines have a narrow pitch, preferably a pitch ranging from 20 to 70 μm in order to improve the aperture ratio and facilitate a discharge.

It is preferred that each of the electrode lines 900a, 900b, 900c, and 900d, and 910a, 910b, 910c, and 910d of the sustain electrode pair 900 and 910 have a thickness of 3 to 7 μm. The critical meaning of the highest limit value and the lowest limit value of the electrode line thickness is the same as that descried with reference to FIG. 2 and will not be described.

Distances c1, c2, and c3 between the four electrode lines constituting the sustain electrode 900 or 910 may be the same or different from each other, and pitches d1, d2, d3, and d4 of the four electrode lines constituting the sustain electrode 900 or 910 may also be the same or different from each other.

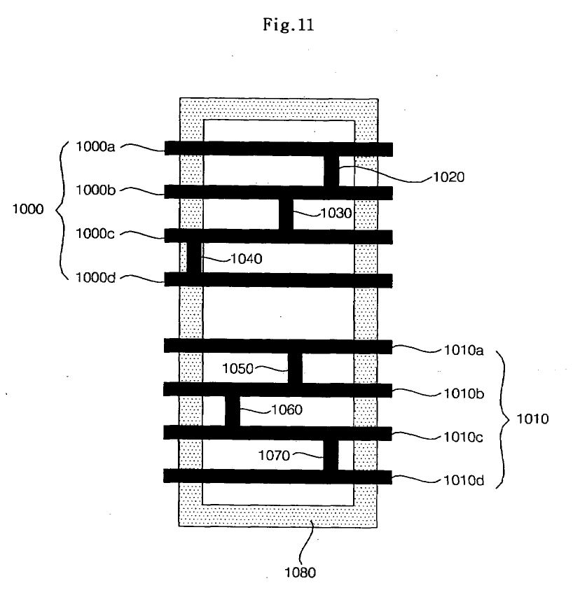

FIG. 11 is a cross-sectional view showing a seventh embodiment of the sustain electrode structure according to the present invention.

Referring to FIG. 11, sustain electrodes 1000 and 1010 includes four electrode lines 1000a, 100b, 1000c, and 1000d, and 1010a, 1010b, 1010c, and 1010d, respectively, which cross a discharge cell. The electrode lines cross the discharge cell and extend in one direction of the plasma display panel.

It is preferred that each of the electrode lines 1000a, 1000b, 1000c, and 1000d, and 1010a, 1010b, 1010c, and 1010d of the sustain electrode pair have a thickness of 3 to 7 μm. The critical meaning of the highest limit value and the lowest limit value of the electrode line thickness is the same as that descried with reference to FIG. 2 and will not be described.

Each of bridge electrodes 1020, 1030, 1040, 1050, 1060, and 1070 connects two electrode lines. The bridge electrodes 1020, 1030, 1040, 1050, 1060, and 1070 allow an initiated discharge to be easily diffused into electrode lines that are far from the center of the discharge cell. As shown in FIG. 11, the locations of the bridge electrodes 1020, 1030, 1040, 1050, 1060, and 1070 may not be identical to each other and any one (for example, the bridge electrode 1040) of the bridge electrodes 1020, 1030, 1040, 1050, 1060, and 1070 may be located on a barrier rib 1080.

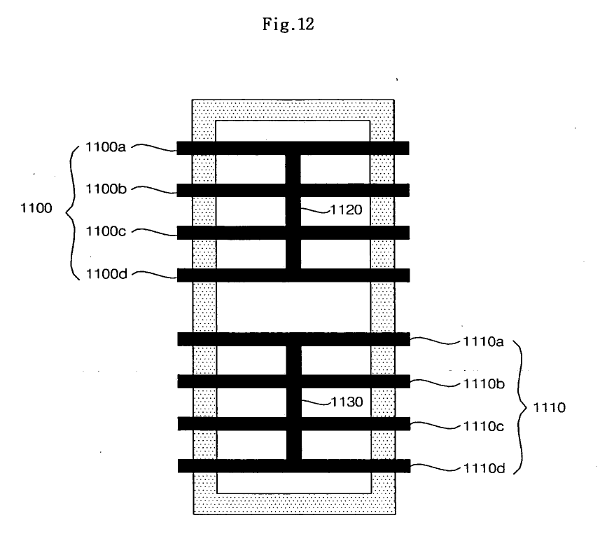

FIG. 12 is a cross-sectional view showing an eighth embodiment of the sustain electrode structure according to the present invention.

Referring to FIG. 12, the bridge electrodes connecting the electrode lines are formed on the same location, unlike FIG. 11. One bridge electrode 1120 that connects four electrode lines 1100a, 1100b, 1100c, and 1100d is formed in a sustain electrode 1100, and one bridge electrode 1130 that connects four electrode lines 1110a, 1110b, 1110c, and 1110d is formed in a sustain electrode 1110.

It is preferred that each of the electrode lines 1100a, 1100b, 1100c, 1100d, 1110a, 1110b, 1110c, and 1110d of the sustain electrode pair have a thickness of 3 to 7 μm. The critical meaning of the highest limit value and the lowest limit value of the electrode line thickness is the same as that descried with reference to FIG. 2 and will not be described.

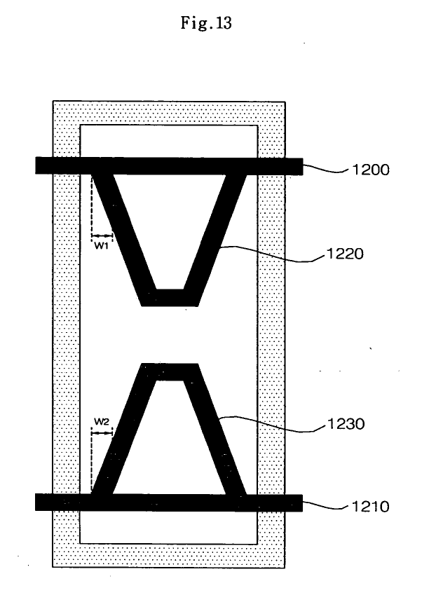

FIG. 13 is a cross-sectional view showing a ninth embodiment of the sustain electrode structure according to the present invention.

Referring to FIG. 13, protruding electrodes 1220 and 1230a respectively including closed loops with respect to electrode lines 1200 and 1210 are formed. The protruding electrodes 1220 and 1230 including the closed loops, respectively, as shown in FIG. 13 serve to lower the firing voltage and also to improve the aperture ratio. It is to be understood that the shapes of the protruding electrode and the closed loop may be changed in various ways.

It is preferred that each of the electrode lines 1200 and 1210 of the sustain electrode pair be in a range of 3 to 7 μm. The critical meaning of the highest limit value and the lowest limit value of the electrode line thickness is the same as that descried with reference to FIG. 2 and will not be described.

It is also preferred that line widths W1 and W2 of the protruding electrodes 1220 and 1230 range from 35 to 45 μm. If the protruding electrodes 1220 and 1230 have the above-mentioned line widths W1 and W2, a sufficient aperture ratio of a panel can be secured. It is therefore possible to prevent a reduction in the luminance of an image, which is incurred since light reflected toward the front of a display device is precluded by the protruding electrodes.

Furthermore, a distance between the two protruding electrodes 1220 and 1230 may preferably range from 15 to 165 μm. The critical meaning of the highest limit value and the lowest limit value of the distance between the protruding electrodes is the same as that descried with reference to FIG. 5 and will not be described.

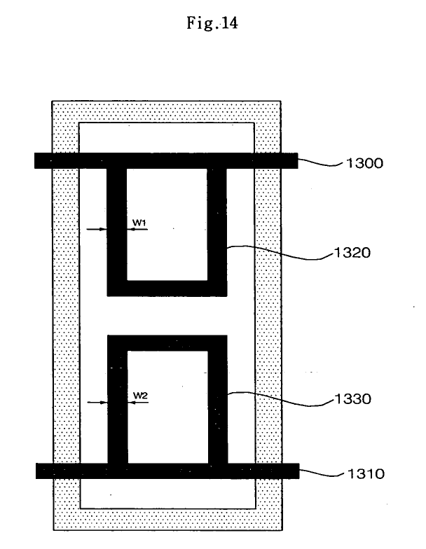

FIG. 14 is a cross-sectional view showing a tenth embodiment of the sustain electrode structure of the plasma display panel according to the present invention.

Referring to FIG. 14, protruding electrodes 1320 and 1330 respectively including square closed loops with respect to electrode lines 1300 and 1310 are formed.

It is preferred that each of the electrode lines 1300 and 1310 of the sustain electrode pair be in a range of 3 to 7 μm. The critical meaning of the highest limit value and the lowest limit value of the electrode line thickness is the same as that descried with reference to FIG. 2 and will not be described.

It is also preferred that line widths W1 and W2 of the protruding electrodes 1320 and 1330, respectively, be within a range of 35 to 45 μm. The critical meaning of the highest limit value and the lowest limit value of the line widths W1 and W2 of the protruding electrodes 1320 and 1330 is the same as that descried with reference to FIG. 2 and will not be described.

Furthermore, a distance between the two protruding electrodes 1320 and 1330 may range from 15 to 165 μm. The critical meaning of the highest limit value and the lowest limit value of the distance between the protruding electrodes is the same as that descried with reference to FIG. 2 and will not be described.

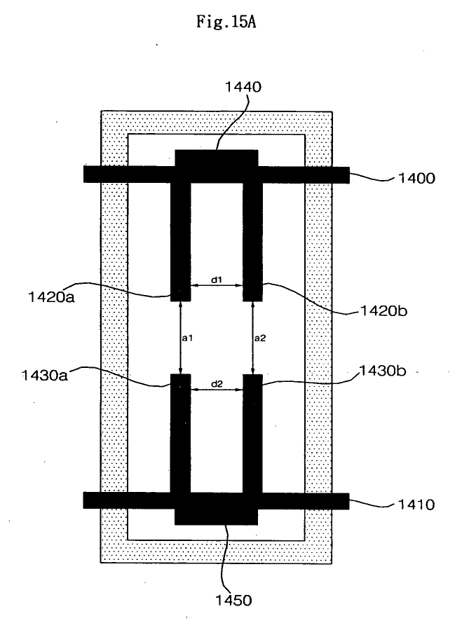

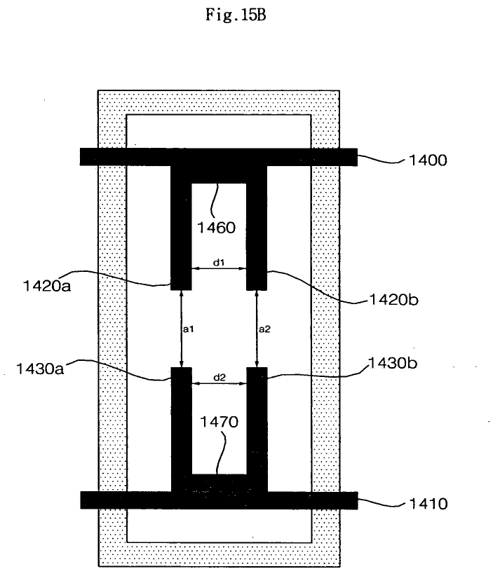

FIGS. 15A and 15B cross-sectional view showing an eleventh embodiment of the sustain electrode structure of the plasma display panel according to the present invention.

Referring to FIGS. 15A and 15B, the sustain electrode structure includes first protruding electrodes 1420a and 1420b, and 1430a and 1430b, which are projected toward the center of a discharge cell with respect to electrode lines 1400 and 1410, respectively, and second protruding electrodes 1440 and 1450 (refer to FIG. 15A), which are projected in an opposite direction to that of the center of a discharge cell, and 1460 and 1470 (refer to FIG. 15B), which are projected toward the center of the discharge cell.

It is preferred that in the electrode line 1400, the two first protruding electrodes 1420a and 1420b be projected toward the center of the discharge cell and one second protruding electrode 1440 be projected in an opposite direction to that of the center of the discharge cell, as shown in FIG. 15A. Furthermore, it is preferred that in the electrode line 1410, the two first protruding electrodes 1430a and 1430b be projected toward the center of the discharge cell and one second protruding electrode 1450 be projected in an opposite direction to that of the center of the discharge cell. Alternatively, the second protruding electrodes 1460 and 1470 may be projected toward the center of the discharge cell, as shown FIG. 15b.

It is preferred that each of the electrode lines 1400 and 1410 of the sustain electrode pair have a thickness of 3 to 7 μm. The critical meaning of the highest limit value and the lowest limit value of the electrode line thickness is the same as that descried with reference to FIG. 2 and will not be described.

It is also preferred that each of the first protruding electrodes 1420a, 1420b, 1430a, and 1430b have a pitch of 35 to 45 μm. The critical meaning of the highest limit value and the lowest limit value of the protruding electrode pitch is the same as that descried with reference to FIG. 5 and will not be described.

It is preferred that each of distances d1 and d2 between the two first protruding electrodes projected from one electrode line be 50 to 100 μm when a plasma display panel is a 42-inch size and VGA resolutions, 50 to 100 μm when a plasma display panel is a 42-inch size and XGA resolutions, and 40 to 90 μm when a plasma display panel is a 50-inch size and XGA resolutions. The critical meaning of the highest limit value and the lowest limit value of the distances d1 and d2 between the first protruding electrodes is the same as that descried with reference to FIG. 7 and will not be described.

It is also preferred that a distance between another first protruding electrodes, i.e., a distance a1 between the electrodes 1420a and 1430a or a distance a2 between the electrodes 1420b and 1430b be in a range of 15 to 165 μm. The critical meaning of the highest limit value and the lowest limit value of the distances between the protruding electrodes is the same as that descried with reference to FIG. 5 and will not be described.

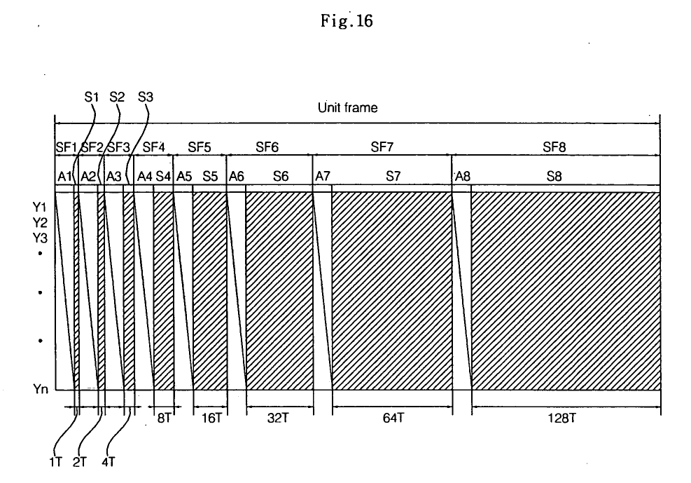

FIG. 16 is a timing diagram illustrating an embodiment of a method of driving the plasma display panel constructed above with one frame being time-divided into a plurality of subfields according to the present invention.

A unit frame may be divided into a predetermined number (for example, eight subfields SF1, . . . , SF8) in order to realize time-dividing gray level display. Furthermore, each of the subfields SF1, . . ., SF8 is divided into a reset period (not shown), address periods A1, . . . , A8, and sustain periods S1, . . . , S8. According to the present invention, the reset period may be omitted from at least one of the plurality of subfields. For example, the reset period may exist only in the first subfield or may exist only in a subfield approximately located between the first subfield and the whole subfield.

In each of the address periods A1, . . . , A8, a display data signal is applied to address electrodes X and scan pulses corresponding to respective scan electrodes Y are sequentially applied to the address electrodes X.

In each of the sustain periods S1, . . . , S8, a sustain pulse is alternately applied to the scan electrode Y and a sustain electrode Z. Accordingly, a sustain discharge is generated in discharge cells on which wall charges are formed in the address periods A1, . . . , A8.

The luminance of the plasma display panel is proportional to the number of sustain discharge pulses within the sustain periods S1, . . . , S8 occupied in the unit frame. In the case where one frame forming one image is represented by eight subfields and 256 gray levels, a different number of sustain pulses may be sequentially allocated to the respective subfields in the ratio of 1, 2, 4, 8, 16, 32, 64, and 128. In order to obtain luminance of 133 gray levels, a sustain discharge can be generated by addressing cells during the subfield1 period, the subfield3 period, and the subfield8 period.

The number of sustain discharges allocated to each subfield may be varied depending on the weight of a subfield according to the APC (Automatic Power Control) step. That is, an example in which one frame is divided into eight subfields has been described with reference to FIG. 16. However, the present invention is not limited to the above example, but the number of subfields forming one frame may be varied depending on the design specifications. For example, the plasma display panel may be driven by dividing one frame into eight or more subfields, such as 12 or 16 subfields.

Furthermore, the number of sustain discharges allocated to each subfield may be changed in various ways in consideration of a gamma characteristic or a panel characteristic. For example, the degree of a gray level allocated to the subfield4 can be lowered from 8 to 6 and the degree of a gray level allocated to the subfield6 can be lowered from 32 to 34.

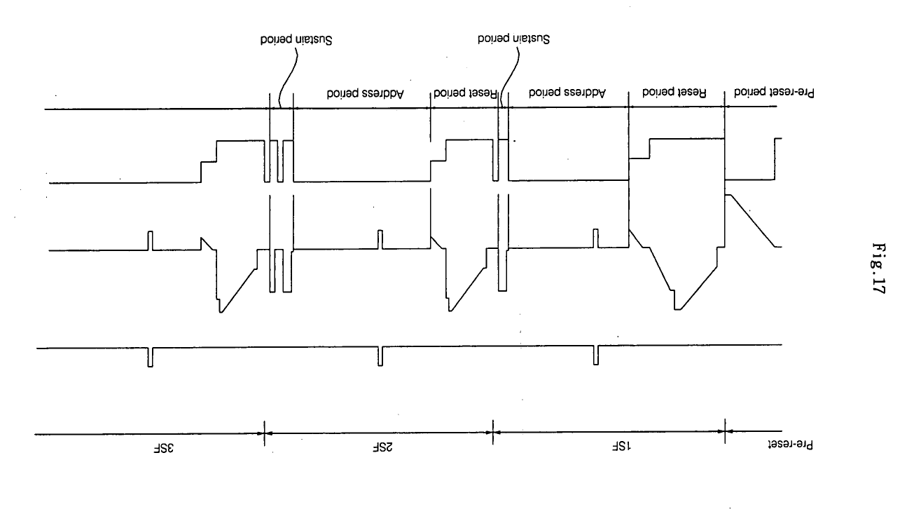

FIG. 17 is a timing diagram illustrating an embodiment of driving signals for driving the plasma display panel with respect to divided subfields.

There is a pre-reset period for forming positive wall charges on the scan electrode Y and negative wall charges on the sustain electrode Z. Each subfield includes a reset period for initializing discharge cells of the whole screen using wall charge distributions formed by the pre-reset period, an address period for selecting discharge cells, and a sustain period for sustaining the discharge of selected discharge cells.

The reset period includes a setup period and a set-down period. In the setup period, a ramp-up waveform ramp-up is applied to all the scan electrodes at the same time. Therefore, a minute discharge is generated in the entire discharge cell and wall charges are generated accordingly.

In the set-down period, a ramp-down waveform ramp-down, which falls from a positive voltage lower than a peak voltage of the ramp-up waveform, is applied to the entire scan electrodes Y at the same time. Therefore, an erase discharge is generated in the entire discharge cells, thereby erasing unnecessary charges from the wall charges generated by the set-up discharge and spatial charges.

In the address period, a negative scan signal scan is sequentially applied to the scan electrodes, and at the same time, a positive data signal data is applied to the address electrode X. Therefore, an address discharge is generated due to a voltage difference between the scan signal scan and the data signal data and a wall voltage generated during the reset period, so that cells are selected. Meanwhile, during the set-down period and the address period, a signal that maintains a sustain voltage Vs is applied to the sustain electrode.

In the sustain period, a sustain pulse is alternately applied to the scan electrode and the sustain electrode, so that a sustain discharge is generated between the scan electrode and the sustain electrode in a surface discharge form.

The driving waveforms shown in FIG. 17 are an embodiment of signals for driving the plasma display panel according to the present invention. The present invention is not limited to the waveforms shown in FIG. 17. For example, the pre-reset period may be omitted, the polarity and voltage level of the driving signals shown in FIG. 17 may be changed, if needed, and an erase signal for erasing wall charges after the sustain discharge is completed may be applied to the sustain electrode. The present invention may also be applied to a single sustain driving method in which the sustain signal is applied to either the scan electrode Y or the sustain electrode Z in order to generate the sustain discharge.

In accordance with the plasma display apparatus according to the present invention, since the transparent electrodes made of ITO are removed, the manufacturing cost of the plasma display panel can be saved. Furthermore, the protruding electrodes are projected from the scan electrode or the sustain electrode line to the center of the discharge cell or in an opposite direction to that of the center of the discharge cell. Accordingly, a firing voltage can be lowered and discharge diffusion efficiency within the discharge cell can be increased.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A plasma display apparatus including an upper substrate, first and second electrodes formed on the upper substrate, a lower substrate disposed opposite to the upper substrate, a third electrode formed on the lower substrate, and a barrier rib formed on the lower substrate, for partitioning a discharge cell,
wherein at least one of the first and second electrodes consists of one layer, and
the barrier rib is formed using a photosensitive material, and the photosensitive material includes an inorganic component containing glass particle, and an organic component containing a photosensitive compound.

2. The plasma display apparatus of claim 1, wherein at least one of the first and second electrodes comprises:
a line unit formed in a direction to cross the third electrode; and
a projection unit projected from the line unit.

3. The plasma display apparatus of claim 1, wherein the inorganic component contains the glass particle of 60 weight % or more.

4. The plasma display apparatus of claim 1, wherein a difference between an average refractive index of the inorganic component and an average refractive index of the organic component is 0.2 or less.

5. The plasma display apparatus of claim 1, wherein an average refractive index of the inorganic component is set in a range of 1.5 to 1.65.

6. The plasma display apparatus of claim 1, wherein a top width of the barrier rib is set in a range of 30 to 50 μm.

7. The plasma display apparatus of claim 1, wherein a bottom width of the barrier ribs is set in a range of 60 to 80 μm.

8. The plasma display apparatus of claim 1, wherein a height of the barrier rib is set in a range of 100 to 140 μm.

9. The plasma display apparatus of claim 1, wherein the barrier rib has a dielectric constant of 6 to 10.

10. The plasma display apparatus of claim 1, wherein a dielectric layer having a thickness of 30 to 40 μm is formed on at least one of the upper substrate and the lower substrate.

11. The plasma display apparatus of claim 1, wherein a dielectric layer is formed on at least one of the upper substrate and the lower substrate, and
a top width of the barrier rib and a thickness of the dielectric layer have a ratio of 5:3 to 3:4.

12. The plasma display apparatus of claim 1, wherein a dielectric layer is formed on at least one of the upper substrate and the lower substrate, and
a bottom width of the barrier rib and a thickness of the dielectric layer have a ratio of 8:3 to 3:2.

13. The plasma display apparatus of claim 1, wherein a plasma display panel in which the upper substrate and the lower substrate are formed includes lead (Pb) of 0.1 weight % or 1000 PPM or less.

14. The plasma display apparatus of claim 1, wherein the inorganic component includes titanium oxide (TiO₂).

15. The plasma display apparatus of claim 1, wherein the glass particle includes at least one of lithium oxide, natrium oxide, and potassium oxide, which has 3 to 20 weight %.

16. The plasma display apparatus of claim 1, wherein the glass particle includes at least one of bismuth oxide and lead oxide, which has 5 to 50 weight %.

17. The plasma display apparatus of claim 1, wherein the glass particle includes at least one of bismuth oxide and lead oxide, which is 5 to 30 weight %, and at least one of lithium oxide, natrium oxide, and potassium oxide, which has 3 to 15 weight %.

18. The plasma display apparatus of claim 1, wherein a dielectric layer is formed on the upper substrate, and at least one of the first and second electrodes has a color darker than that of the dielectric layer.

19. A plasma display apparatus including an upper substrate, first and second electrodes formed on the upper substrate, a lower substrate disposed opposite to the upper substrate, a third electrode formed on the lower substrate, and a barrier rib formed on the lower substrate, for partitioning a discharge cell,
wherein at least one of the first and second electrodes consists of one layer, and
the barrier rib is formed using a photosensitive material, the photosensitive material includes an inorganic component containing glass particle, and an organic component containing a photosensitive compound, and a difference between an average refractive index of the inorganic component and an average refractive index of the organic component is set in a range of −0.1 to 0.2.

20. A plasma display apparatus including an upper substrate, first and second electrodes formed on the upper substrate, a lower substrate disposed opposite to the upper substrate, a third electrode formed on the lower substrate, and a barrier rib formed on the lower substrate, for partitioning a discharge cell,
wherein at least one of the first and second electrodes is formed of one layer, and includes a line unit formed in a direction to cross the third electrode and a projection unit projected from the line unit, and
the barrier rib is formed using a photosensitive material, and the photosensitive material includes an inorganic component having an average refractive index of 1.5 to 1.65.
